(19) United States
(12) Patent Application Publication
(10) Pub. No.: US 2003/0148772 A1
(43) Pub. Date: Aug. 7, 2003

(54) System and method for generating a directional indicator on a wireless communications device display

(76) Inventor: Haim Ben-Ari, San Diego, CA (US)

Correspondence Address: Kyocera Wireless Corp., Attn: Patent Department, P.O. Box 928289, San Diego, CA, 92192-8289, US

(21) Appl. No.: 10/072,714

(22) Filed: Feb. 5, 2002

(51) Int. Cl. H04Q 7/20

(52) U.S. Cl. 455/456; 455/457; 455/566

(57) ABSTRACT

A system and a method are provided for generating a directional indicator on a mobile wireless communications device display. The system comprises a magnetic detection circuit, a direction circuit and a user interface screen. The magnetic detection circuit determines the orientation of the wireless device in a magnetic field and supplies a magnetic bearing signal responsive to the determined orientation. The direction circuit accepts the magnetic bearing signal and data defining a relationship between the magnetic bearing and a reference axis. The direction circuit determines the direction of the reference axis based on the defined relationship and includes the direction of the reference axis in a reference axis signal. For example, the reference axis can be aligned with an axis on the user interface screen. As the screen and the screen axis rotate, the reference axis rotates to maintain the alignment. The screen axis could be aligned with the long axis of the wireless device housing and point to the end of the screen opposite the keypad (what typically might be considered the top of the wireless device). In this manner, the orientation of the screen axis corresponds to the direction in which the long axis of the wireless device housing is pointing. The direction circuit communicates the reference axis signal containing the reference axis direction to the user interface screen. In response to receiving the reference axis signal, the screen displays the direction of the reference axis.

### BACKGROUND OF THE INVENTION 1. Field of the Invention

This invention generally relates to wireless communications devices and, more particularly, to a system and method for generating a directional indicator of a wireless communications device.

2. Description of the Related Art

Conventionally, wireless communications devices do not have the capability to provide a direction or magnetic bearing. In a number of instances, the user of a wireless device may wish to determine a direction or magnetic bearing. For example, a user may know that a landmark or destination is located in a particular direction, but is unable to determine that direction with respect to their present location. In these instances, the user must rely on a separate device such as a standard compass, or obtain the direction from some external resource. As a result, the user suffers the inconvenience of procuring and carrying a separate device for determining direction or attempting to locate and interface with the external resource.

Stand-alone electronic digital compasses and wristwatches with digital compasses are known. It also is known to incorporate map and global positioning system (GPS) information into the display of a wireless device. However, GPS information does not necessarily provide direction, only location. The user of the GPS receiver must be moving before a change of position can be observed, and from the position change, a direction determined. If the user is moving slowly, or if the display is not sophisticated enough to track a change of position, it still may be difficult to determine direction.

It would be advantageous if a wireless communications device could provide a direction or magnetic bearing to enable a user of the device to orient themselves with respect to the magnetic direction.

For devices with GPS capabilities, it would be advantageous if direction or magnetic bearing information could be incorporated into GPS and map information to augment map displays and operations associated with locating and reaching destinations.

### SUMMARY OF THE INVENTION

The present invention was created to address the problem of providing an indication of direction on a wireless communications device display. Even when the wireless device has access to GPS information, and creates a map display showing the user's position, the user may be unable to orient themselves in a desired direction. The invention provides this capability by determining the magnetic bearing of the device and indicating the determined magnetic bearing to the user. For example, a reference axis can be generated to display the direction in which the wireless device is pointing. For devices with GPS capabilities, the reference axis is incorporated into a map display.

Accordingly, a system is provided for generating a directional indicator on a mobile wireless communications device display. The system comprises a magnetic detection circuit, a direction circuit, and a user interface indicator, such as a screen. The magnetic detection circuit determines the orientation of the wireless device in a magnetic field and supplies a magnetic bearing signal responsive to the determined orientation. The direction circuit accepts the magnetic bearing signal and data defining a relationship between the magnetic bearing and a reference axis. The direction circuit determines the direction of the reference axis based on the defined relationship and includes the direction of the reference axis in a reference axis signal. The direction circuit communicates the reference axis signal containing the reference axis direction to the user interface indicator. In response to receiving the reference axis signal, the indicator presents the direction of the reference axis.

The present invention system may operate at two levels or frames of reference, and the reference axis is the link between these two levels. The first frame of reference is relative and is concerned with useful presentation of the direction information. The second frame of reference is the earth's magnetic field and is represented by the magnetic bearing signal. The reference axis is the mechanism that converts the magnetic bearing information into a useful presentation on a display.

In one version of the system, the reference axis can be aligned with a screen axis, for example, along the long axis of the device. As the screen and the screen axis rotate, the reference axis rotates, and the resulting change in magnetic bearing is displayed. Thus, a user is able to determine a direction by pointing their wireless device. The use of the present invention system enables a wireless communications device user to orient themselves with respect to magnetic direction and, for devices with GPS capabilities, to enhance operations associated with mapping, locating, and reaching destinations. Additional details of the above-described system and a method for providing an indication of direction on a wireless communications device display are presented below.

### BRIEF DESCRIPTION OF THE DRAWINGS

FIG. 1 is a schematic block diagram depicting the system for generating a directional indicator on the display of a wireless communications device in accordance with the present invention.

FIG. 2 is a pictorial representation of the wireless device of FIG. 1 showing the use of the present invention system as a directional pointer.

FIGS. 3a and 3b are pictorial representations showing the present invention system being used to point to a landmark.

FIGS. 4a and 4b are pictorial representations of displays for the user interface screen of FIG. 1 showing rotation of the map display.

FIGS. 5a and 5b are pictorial representations of displays for the user interface screen of FIG. 1 showing the display of directional information on a map.

FIG. 6 is a flowchart illustrating the method for generating a directional indicator on the display of a wireless communication device in accordance with the present invention.

FIG. 7 is a flowchart detailing the use of the present invention method as a directional pointer.

FIG. 8 is a flowchart detailing the present invention method for pointing to a landmark.

FIG. 9 is a flowchart detailing the present invention method for rotating a map display.

FIG. 10 is a flowchart detailing the present invention method for displaying directional information on a map.

### DETAILED DESCRIPTION OF THE PREFERRED EMBODIMENTS

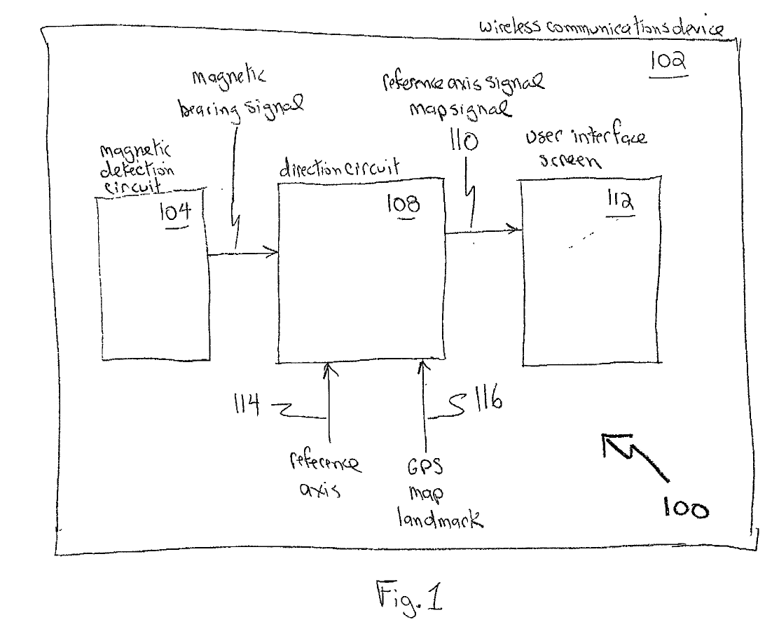

FIG. 1 is a schematic block diagram depicting the system 100 for generating a directional indicator on the display of a wireless communications device in accordance with the present invention. A wireless communications device 102 includes a magnetic detection circuit 104 to determine orientation in a magnetic field. The magnetic detection circuit 104 has an output on line 106 to supply a magnetic bearing signal responsive to the determined orientation. A direction circuit 108 has an input on line 106 to accept the magnetic bearing signal and an output on line 110 to communicate a reference axis signal. A user interface screen 112 has an input on line 110 to receive the reference axis signal and an output display responsive to the magnetic bearing of the wireless communication device. The display can take a number of forms, as described below. The reference axis is further explained in the following paragraph.

The direction circuit 108 has another input on line 114 to accept data defining a relationship between the magnetic bearing and a reference axis, as well as other operations involving the reference axis. In some aspects of the system, the relationship is predefined. To better understand the function of the reference axis, consider that the system 100 operates at two levels or frames of reference, and that the reference axis is the link between these two levels. The first frame of reference is relative and internal to the system 100. The system 100 performs the operations required to produce the desired display or result within this frame of reference, and the reference axis is used to “mark” the result of the internal operations. For example, in one aspect of the invention described below, the system 100 operations include aligning the reference axis with a screen axis. The second frame of reference is absolute and external to the system 100. This frame of reference is the earth's magnetic field and is represented by the magnetic bearing signal. In order to yield a useful direction, the magnetic bearing information (second frame of reference) must be displayed in a meaningful way (the first frame of reference). That is, the raw direction data is translated into reference axis information.

The direction circuit 108 determines the direction of the reference axis based on the defined relationship and includes the direction of the reference axis in the reference axis signal. The user interface screen 112 displays the reference axis direction.

In one aspect of the invention, the system 100 acts as a digital compass, and the reference axis is aligned with magnetic North. In response, the screen 112 displays magnetic North as an icon, for example, an arrow pointing to magnetic North. That is, the reference axis is a compass display generated from the magnetic bearing information.

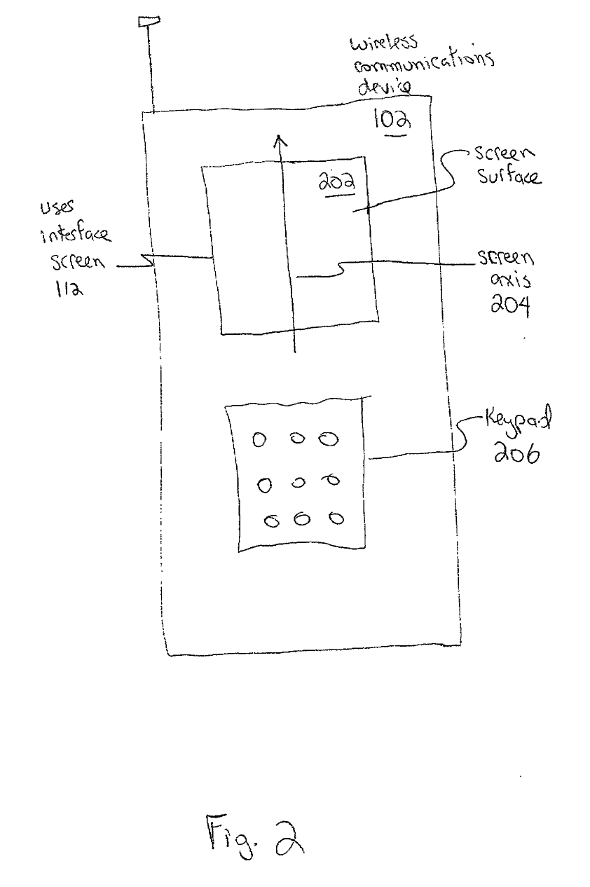

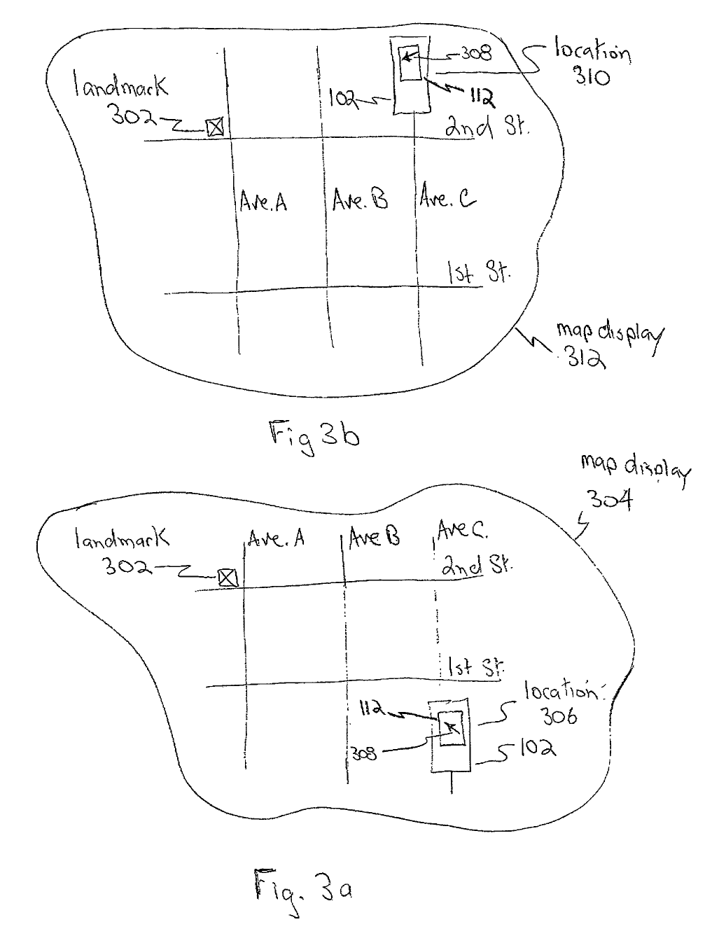

FIG. 2 is a pictorial representation of the wireless device 102 of FIG. 1 showing the use of the system 100 as a directional pointer. FIG. 2 and FIGS. 3a, 3b, 4a, 4b, 5a, and 5b are not drawn to scale and elements in the representations are not necessarily in proper proportion. In one aspect of the invention, the system 100 acts as a directional pointer. To accomplish this, the user interface screen 112 has a surface 202 with a screen axis 204 defined with respect to the surface. In FIG. 2, the screen axis 204 is aligned with the long axis of the wireless device 102 housing and can be thought of as pointing to the top of the wireless device 102 (away from the keypad 206). The direction circuit defines the reference axis to be fixedly aligned with the screen axis 204. The reference axis direction is included in the reference axis signal and is responsive to the rotation of the screen axis 204.

In FIG. 2, the reference axis direction is the same as the screen axis 204 direction, which is the same as the direction to which the top of the wireless device 102 is pointing. In response to the reference axis signal, the user interface screen 112 displays the direction of the screen axis 204. For example, the user of the system 100 can point the wireless device 102 at a landmark and the screen will supply a display with the direction to the landmark, given with respect to the position of the wireless device 102. Thus, the magnetic bearing information is translated into a display of the reference axis, with the reference axis indicating the direction in which the wireless device 102 is pointing. In some aspects of the system, the magnetic detection circuit is aligned along the same axis as the screen axis 204. Then, the reference axis is found by performing a 1-to-1 translation. The display of direction can be in terms a quadrants (North, South, East, and West), sub-quadrants (i.e. North-Northeast), or in degrees. The present invention system is not limited to any particular system of reference.

FIGS. 3a and 3b are pictorial representations showing the present invention system 100 being used to point to a landmark. The following discussion also includes references to FIG. 1. A landmark 302 can be determined and input by the wireless device 102 user, or it can be selected from a menu of well-known sites in the area. In some aspects, the wireless device 102 is loaded with a set of landmarks having predetermined locations. In one aspect of the invention, the system 100 can be used to provide a display that will point to the landmark 302 regardless of the orientation of the wireless device 102. This aspect is useful for a user who may need to make a series of maneuvers while approaching the landmark 302, and wishes to maintain the bearing of the landmark 302 during the maneuvers. The direction circuit 108 has an input on line 116 to receive global positioning system (GPS) location information and an input on line 116 for selecting a landmark 302 having a known or predetermined location. The direction circuit 108 uses the GPS information to locate the wireless device 102 and generates a reference axis signal defining a vector between the wireless communications device 102 location and the landmark 302 location. That is, the reference axis always points from the wireless device 102 location to the location of the landmark 302. In response to the reference axis signal, the screen 112 displays the direction to the location of the landmark 302. This display could be an icon such as an arrow, or an alphanumeric display. Returning to FIG. 3a, at location 306 in map display 304, the arrow 308 on the screen 112 is pointing to the landmark 302. In FIG. 3b, as the wireless device 102 continues to move north to location 310 in map display 312, the arrow 308 rotates and continues to point to landmark 302.

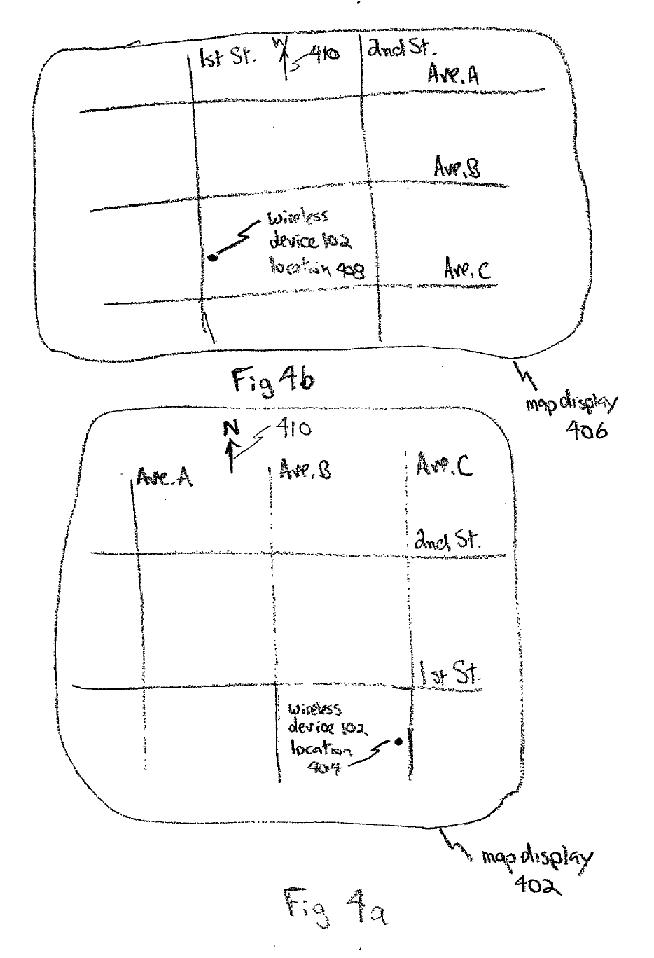

FIGS. 4a and 4b are pictorial representations of displays for the user interface screen of FIG. 1 showing rotation of the map display. The following discussion also includes references to FIG. 1. In one aspect of the invention, the system 100 supplies a map showing the wireless device 102 location. The map rotates in response to the movement of the wireless device 102. In this aspect, the direction circuit 108 has an input to receive GPS location information on line 116 and an input to receive map information oriented in a directional coordinate system on line 116. The GPS information can be supplied by a connected GPS receiver, or an internal GPS receiver (not shown). Typically, the map features, such as streets and addresses, are oriented with respect to the cardinal points of the compass. For example, the top of the map could be pointing North. The direction circuit 108 uses the GPS and map information to generate a map showing the location of the wireless communications device 102. The direction circuit 108 has an output to supply a map signal for displaying the map with the reference axis signal on line 110. The user interface screen 112 has an input to accept the map signal on line 110 and displays the map in response to the map signal. Without additional direction data, the wireless device 102 is a point on the map and no direction display is associated with the device 102 location.

The user interface screen has a screen axis (204, see FIG. 2). The direction circuit aligns the reference axis with the screen axis, and the screen axis with the directional coordinate system. For example, the screen axis could be aligned with North on the map. As the screen axis (wireless device) rotates, the direction circuit 108 rotates the map directional coordinate system to maintain the alignment with the screen axis. Given the screen axis 204 alignment shown in FIG. 2, the map rotates to remain oriented in the direction in which the user interface screen 112 is pointing (a “straight ahead” orientation). The direction circuit 108 includes the map rotation information in the map signal. The user interface screen 112 displays the map and the map rotation accordingly.

In FIG. 4a, a wireless device 102 is in an automobile driving north on Avenue C (and the screen axis is pointing straight ahead in the car), the map display 402 rotates so that northbound Avenue C is pointing to the top of the screen (straight ahead on the map), and the wireless device 102 location 404 is shown. In this manner, relative positions for landmarks are the same on the map and for the system 100 user. For example, 1st Street is on the left for a driver of the automobile, and 1st Street also is on the left on the map (there is no need for the driver to transpose directions). In FIG. 4b, the automobile turns left onto 1st Street and the map rotates so that westbound 1st Street is now pointing to the top of the screen, the same direction in which the driver is proceeding. Map display 406 also shows the wireless device 102 location 408.

In another aspect of the invention, the system 100 supplies the rotating map display showing the location of the wireless device 102 as described above. However, in this aspect, the system 100 supplies the direction in which the wireless device 102 (screen axis) is pointing (the orientation of the map display). The display can take the form of an icon, such as arrow 410 on map displays 402 and 404 in FIGS. 4a and 4b respectively, originating at the location of the wireless device 102 on the respective map display.

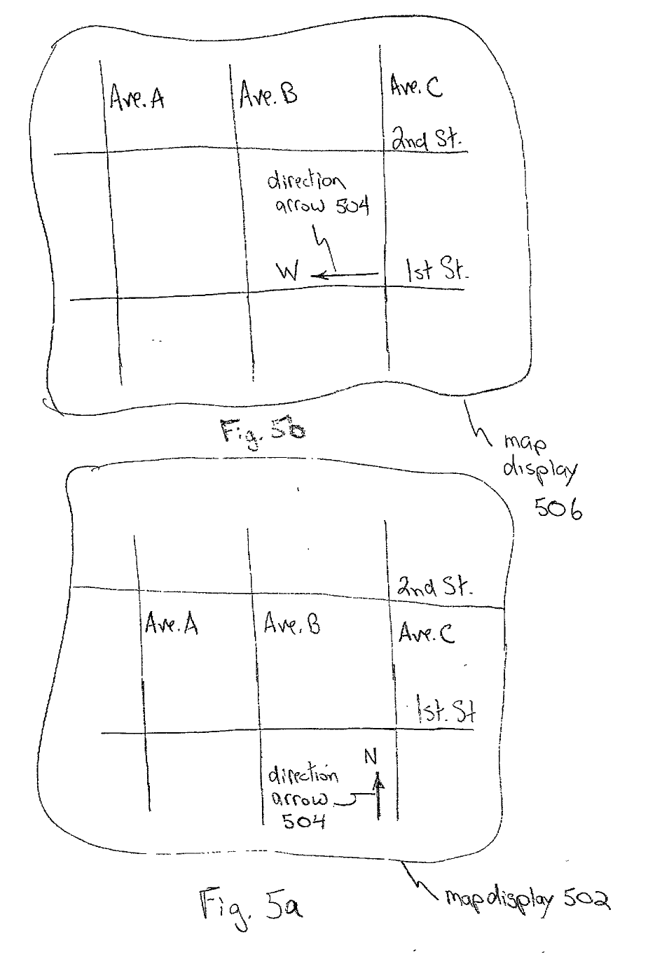

FIGS. 5a and 5b are pictorial representations of displays for the user interface screen of FIG. 1 showing the display of directional information on a map. The user interface screen 112 has a screen axis 204 as described for FIG. 2. The direction circuit aligns the reference axis with the screen axis 204, determines the direction of the reference axis (screen axis 204) within the external frame of reference for the wireless device (the earth's magnetic field) and transposes the screen axis 204 direction into the frame of reference of the map directional coordinate system. Examples are given below. The direction circuit includes the transposed direction information in the map signal, and the user interface screen 112 displays the direction of the screen axis 204 on the map. The display can be in the form of a directional icon, such as an arrow, or alphanumeric characters. For example, in map display 502a, a wireless device is pointing straight ahead in an automobile traveling north on Avenue C. Consequently, an arrow 504 at the location of the wireless device on the map is displayed pointing north. In FIG. 5b, as the automobile turns left onto 1st Street in map display 506, the map orientation on the screen does not change, but the arrow 502 rotates to show that the wireless device is pointing west.

In most instances, there is a discrepancy between magnetic North, the reference used by the magnetic detection circuit, and true North. In some cases, it may be desirable to determine directions with respect to true North, for example, when displaying a map with a directional coordinate system referenced to true North. In one aspect of the invention, the magnetic detection circuit can correct the magnetic bearing with respect to true North. This correction may require the user to input their approximate geographic location to account for regional variations in the magnetic field. Alternately, the wireless device may be loaded with magnetic correction data, assuming use in a particular region.

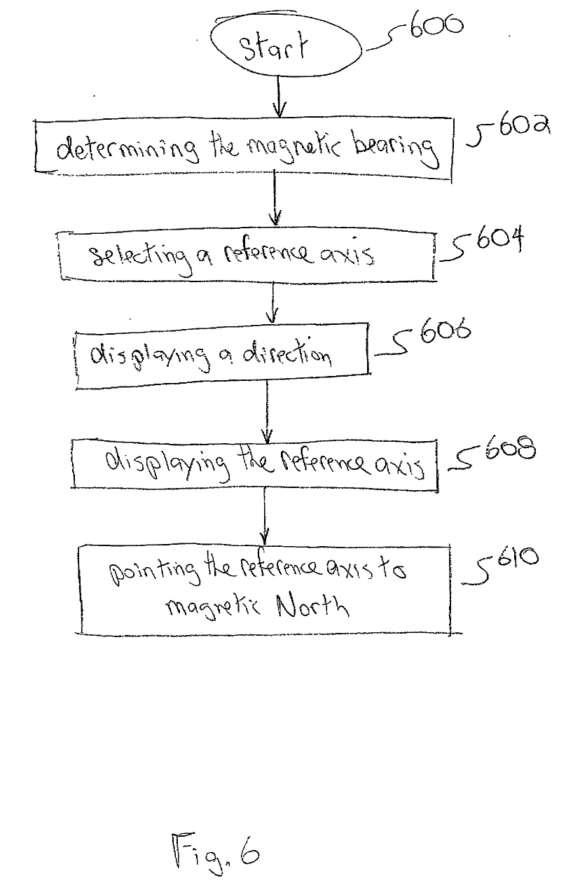

FIG. 6 is a flowchart illustrating the method for generating a directional indicator on the display of a wireless communication device in accordance with the present invention. Although the method and aspects described below are depicted as a sequence of numbered steps for clarity, no order should be inferred from the numbering unless explicitly stated. It should be understood that some of these steps may be skipped, performed in parallel, or performed without the requirement of maintaining a strict order of sequence. The method begins at Step 600. Step 602 determines the magnetic bearing of the wireless communications device. Step 604 selects a reference axis having a predetermined relationship to the magnetic bearing. Step 606 displays a direction responsive to the magnetic bearing. Step 608 displays the reference axis. Step 610 points the reference axis to magnetic North. In one aspect of the invention, determining the magnetic bearing of the wireless communications device in Step 602 includes correcting the magnetic bearing with respect to true North.

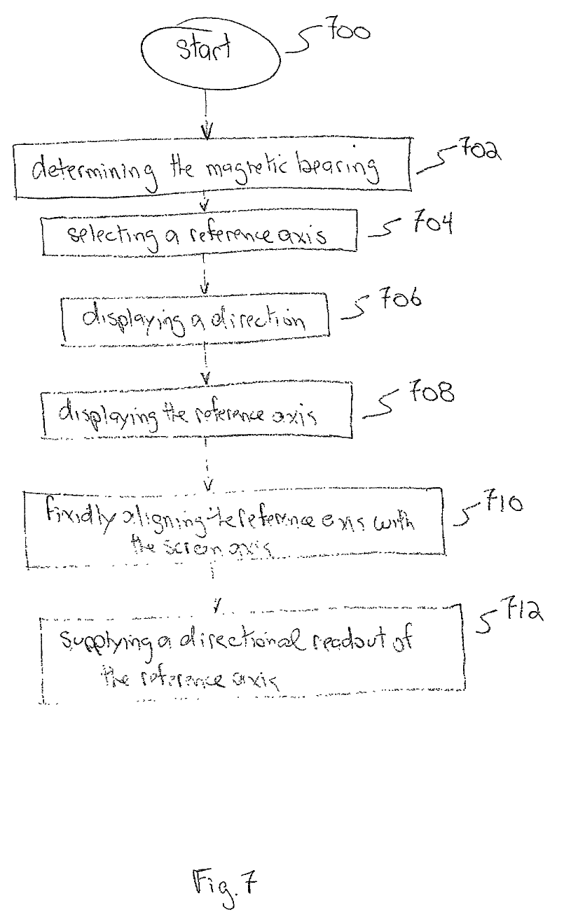

FIG. 7 is a flowchart detailing the use of the present invention method as a directional pointer. The method starts at Step 700. Steps 702, 704, 706 and 708 are the same as Steps 602, 604, 606 and 608 respectively for FIG. 6 and are not explained for the sake of brevity. In this aspect of the invention, the wireless communications device includes a display screen with a screen axis. Then, Step 710 fixedly aligns the reference axis with the screen axis. Step 712 supplies a direction readout of the reference axis responsive to the rotation of the screen axis.

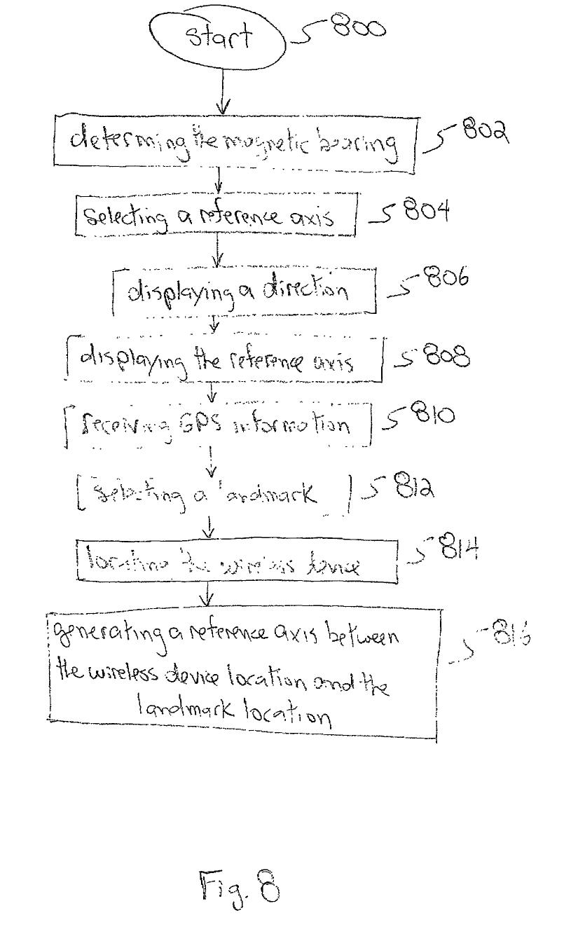

FIG. 8 is a flowchart detailing the present invention method for pointing to a landmark. The method starts at Step 800. Steps 802, 804, 806 and 808 are the same as Steps 602, 604, 606 and 608 respectively for FIG. 6 and are not explained for the sake of brevity. Step 810 receives GPS location information. Step 812 selects a landmark having a predetermined location. Step 814 uses the GPS information to locate the wireless device. Step 816 generates a reference axis between the wireless communications device location and the landmark location. This permits the wireless device to generate a display that points to the landmark location regardless of the orientation of the wireless device.

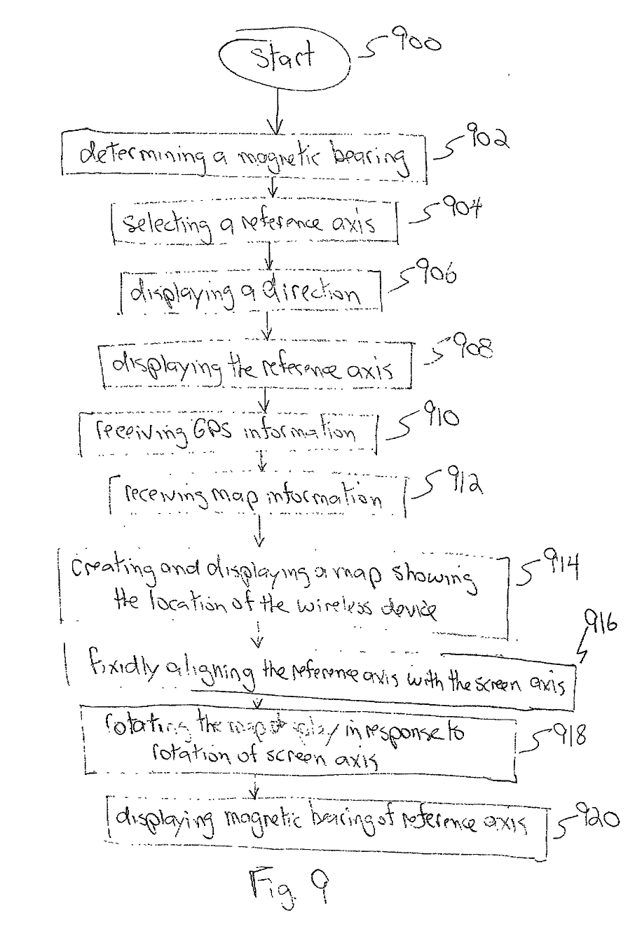

FIG. 9 is a flowchart detailing the present invention method for rotating a map display. The method starts at Step 900. Steps 902, 904, 906 and 908 are the same as Steps 602, 604, 606 and 608 respectively for FIG. 6 and are not explained for the sake of brevity. Step 910 receives GPS location information. Step 912 receives map information. Step 914 creates and displays a map responsive to the map information, showing the wireless communications device location on the map. In this aspect of the method, the wireless communications device includes a display screen with a screen axis. Then, Step 916 fixedly aligns the reference axis with the screen axis. Step 918 rotates the map display in response to the rotation of the screen axis. That is, the map display rotates to supply a “straight ahead” orientation with respect to the direction in which the screen axis is pointing. Step 920 displays the magnetic bearing of the reference axis. That is, the screen displays the direction in which the wireless device is pointing (and in which the map is oriented).

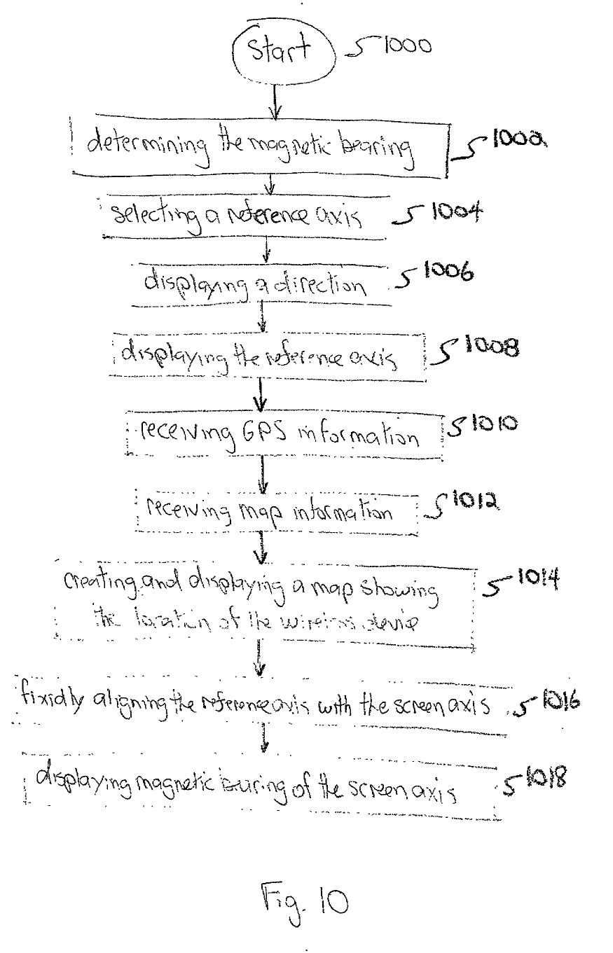

FIG. 10 is a flowchart detailing the present invention method for displaying directional information on a map. The method starts at Step 1000. Steps 1002, 1004, 1006 and 1008 are the same as Steps 602, 604, 606 and 608 respectively for FIG. 6 and are not explained for the sake of brevity. Step 1010 receives GPS location information. Step 1012 receives map information. Step 1014 creates and displays a map responsive to the map information, showing the wireless communications device location on the map. In this aspect of the method, the wireless communications device includes a display screen with a screen axis. Then, Step 1016 fixedly aligns the reference axis with a screen axis on a display screen in the wireless communications device. Step 1018 displays the magnetic bearing of the screen axis. That is, the screen displays the direction in which the wireless device is pointing. In one aspect of the invention, displaying the magnetic bearing of the display screen axis in Step 1018 includes displaying a magnetic bearing icon on the map.

A system and method are provided for generating a directional indicator on the display of a wireless communication device. Examples of the invention have been enabled in conjunction with GPS location and mapping capabilities, however, it should be understood that the present invention is not limited to any particular location or mapping capabilities, or any particular GPS capabilities. Although examples of the invention have included a display screen, it will be appreciated that other indicators, such as LEDs or sound, may be used. The system and method are applicable to other portable electronic devices such as PDAs, palmtop computers, and laptop computers. Other variations and embodiments of the invention will occur to those skilled in the art.

We claim:

1. In a mobile wireless communications device, a method for presenting a direction, the method comprising:
determining the magnetic bearing of the wireless communications device; and,
presenting a direction responsive to the magnetic bearing.

2. The method of claim 1 wherein determining the magnetic bearing of the wireless communications device includes selecting a reference axis having a predetermined relationship to the magnetic bearing; and,
wherein presenting a direction responsive to the magnetic bearing includes displaying the reference axis.

3. The method of claim 2 wherein the reference axis points to magnetic North.

4. The method of claim 2 in which the wireless communications device includes a display screen with a screen axis;
wherein displaying the reference axis includes:
fixedly aligning the reference axis with the screen axis; and,
supplying a direction readout of the reference axis responsive to the rotation of the screen axis.

5. The method of claim 2 further comprising:
receiving global positioning system (GPS) location information;
selecting a landmark having a predetermined location;
using the GPS information to locate the wireless device; and,
generating a reference axis between the wireless communications device location and the landmark location.

6. The method of claim 2 further comprising:
receiving global positioning system (GPS) location information;
receiving map information; and,
wherein displaying the reference axis includes creating and displaying a map display responsive to the map information, showing the wireless communications device location on the map.

7. The method of claim 6 in which the wireless communications device includes a display screen with a screen axis;
wherein displaying the reference axis includes:
fixedly aligning the reference axis with the screen axis; and,
rotating the map display in response to the rotation of the screen axis.

8. The system of claim 7 wherein displaying the reference axis includes displaying the magnetic bearing of the reference axis.

9. The method of claim 6 in which the wireless communications device includes a display screen with a screen axis;
wherein displaying the reference axis includes:
fixedly aligning the reference axis with the screen axis; and,
displaying the magnetic bearing of the screen axis.

10. The method of claim 9 wherein displaying the magnetic bearing of the display screen axis includes displaying a magnetic bearing icon on the map.

11. The method of claim 1 wherein determining the magnetic bearing of the wireless communications device includes correcting the magnetic bearing with respect to true North.

12. In a mobile wireless communications device, a system for indicating a direction, the system comprising:
a magnetic detection circuit to determine orientation in a magnetic field, the magnetic detection circuit having an output to supply a magnetic bearing signal responsive to the determined orientation;
a direction circuit having an input to accept the magnetic bearing signal and an output to communicate a reference axis signal; and,
a user interface screen having an input to receive the reference axis signal and an output display responsive to the magnetic bearing of the wireless communication device.

13. The system of claim 12 wherein the direction circuit has an input to accept data defining a relationship between the magnetic bearing and a reference axis, wherein the direction circuit determines the direction of the reference axis based on the defined relationship, and wherein the reference axis signal includes the direction of the reference axis; and,
wherein the user interface screen displays the reference axis direction.

14. The system of claim 13 wherein the direction circuit defines the reference axis to be magnetic North and the user interface screen includes an icon representing magnetic North.

15. The system of claim 13 wherein the user interface screen has a surface with a screen axis defined with respect to the surface; and,
wherein the direction circuit defines the reference axis to be fixedly aligned with the screen axis and the reference axis signal is responsive to the rotation of the screen axis; and,
wherein the user interface screen displays the direction of the screen axis.

16. The system of claim 13 wherein the direction circuit has an input to receive global positioning system (GPS) location information and an input for selecting a landmark having a predetermined location, wherein the direction circuit uses the GPS information to locate the wireless device and generates a reference axis signal defining a vector between the wireless communications device location and the landmark location.

17. The system of claim 13 wherein the direction circuit has an input to receive GPS location information and an input to receive map information oriented in a directional coordinate system and wherein the direction circuit uses the GPS and map information to generate a map showing the location of the wireless communications device, and wherein the direction circuit supplies a map signal for displaying the map with the reference axis signal; and,
wherein the user interface screen accepts the map signal and displays the map in response to the map signal.

18. The system of claim 17 wherein the user interface screen has a surface with a screen axis defined with respect to the surface;
wherein the direction circuit defines the reference axis to be fixedly aligned with the screen axis and rotates the map directional coordinate system in response to the reference axis; and,
wherein the user interface screen rotates the map display in response to rotations of the screen axis.

19. The system of claim 18 wherein the user interface screen displays the direction of the screen axis.

20. The system of claim 17 wherein the user interface screen has a surface with a screen axis defined with respect to the surface;
wherein the direction circuit defines the reference axis to be fixedly aligned with the screen axis and transposes the screen axis direction onto the map directional coordinate system; and,
wherein the user interface screen displays a map showing the location of the wireless device and the direction of the screen axis.

21. The system of claim 20 wherein the direction circuit generates a directional icon, overlaid on the map.

22. The system of claim 12 wherein the magnetic detection circuit corrects the magnetic bearing with respect to true North.
